(19) United States
(12) Patent Application Publication
(10) Pub. No.: US 2018/0060890 A1
(43) Pub. Date: Mar. 1, 2018

(54) STANDARDIZED CUSTOM SURVEYS

(71) Applicant: ENTIT Software LLC, Sunnyvale, CA (US)

(72) Inventors: Dan Noter, Yehud (IL); Michael Dikman, Yehud (IL); David Malik, Yehud (IL); Yariv Snapir, Yehud (IL)

(21) Appl. No.: 15/556,625

(22) PCT Filed: Mar. 25, 2015
(86) PCT No.: PCT/US2015/022463

§ 371 Date: Sep. 8, 2017

Related U.S. Application Data
(60) Provisional application No. 62/136,188, filed on Mar. 20, 2015.

(51) Int. Cl. G06Q 30/02; G06Q 10/06

(52) U.S. Cl. CPC G06Q 30/0203; G06Q 10/0633; G06Q 10/06393

(57) ABSTRACT

Example implementations relate to standardized custom surveys. For example, a system can include a generate engine to generate, based on a definition, a survey of an entity having a customized data model, a send engine to send the survey to an end-user during a workflow of a lifecycle of the entity responsive to a predetermined workflow event, a collect engine to collect, based on the definition, a response to the survey and a context, and a report engine to generate a report from a table containing standardized responses and standardized contexts collected from a plurality of surveys including the survey of the entity, wherein each of the plurality of surveys has a different customized data model.

### BACKGROUND

Information technology service management (ITSM) is a process-based practice to align the delivery of information technology (IT) services with the demands and tolerances of the organization utilizing them. An organization may possess a broad range of IT capabilities and services to be managed. For example, an IT department of an organization may provide help desk IT support services, incident management, issue management, change management, configuration management, service catalog, request management, asset management, etc.

ITSM may include the management many IT services simultaneously. In order to provide satisfactory service management, organizations may utilize ITSM software/software-as-a-service tools that support the ITSM processes. The ITSM tools can include a workflow management system to manage the lifecycle of different IT processes. For example, an ITSM tool may manage the workflow of a support request from a user experiencing an IT issue, a service request from a user with an idea for an improved IT service, and/or a change request from a user requesting a change in an aspect of his IT service.

Surveying consumers (e.g., end-users) of IT services may be used by IT departments to measure end-user perspectives on a variety of aspects of the ITSM processes. For example, an IT department may deploy a survey to determine a satisfaction level of an end-user after the resolution of a support request, to determine a level of satisfaction of an end-user with a new IT service or device, to determine a perceived risk of a potential change to an IT service, etc.

### BRIEF DESCRIPTION OF THE DRAWINGS

FIG. 1 illustrates an example system, according to the disclosure;

FIG. 2 illustrates an example of a computing device, according to the disclosure;

FIG. 3 illustrates an example of a portion of an environment, according to the disclosure; and

FIG. 4 illustrates a flow chart of an example of a method, according to the disclosure.

### DETAILED DESCRIPTION

Surveying is, in some examples, detached from information technology service management processes. That is, surveys do not interface with ITSM tools, nor do they enable collecting or storing ancillary information related to the information technology (IT) service that may be the subject of the survey.

Surveys may interface was an ITSM tool in a limited manner. For example, an ITSM tool may support sending of an IT related survey relating to one of a limited closed list of a few ITSM entity types (e.g., incident or change). While most ITSM tools do not support survey sending trigger events, some may support a closed list of very few events (e.g., the closing of a support request) over a limited amount of ITSM entity types to act as a survey trigger. Surveys may be limited in the amount of data they can collect. For example, a survey may be limited to collecting the response of four total inquiries. A survey may be unable to integrate into the workflow of an IT entity lifecycle.

Accordingly, examples herein relate to standardized custom surveys. For example, a system for generating based on a definition, a survey of an entity having a customized data model; sending the survey to an end-user during a workflow of a lifecycle of the entity responsive to a predetermined workflow event; collecting, based on the definition, a response to the survey and a context; and a report engine to generate a report from a table containing standardized responses and standardized contexts collected from a plurality of surveys including the survey of the entity, where each of the plurality of surveys has a different customized data model. The examples herein may e.g. be integrated into and interface with an ITSM tool providing a feedback into a workflow of an IT process underlying an ITSM entity.

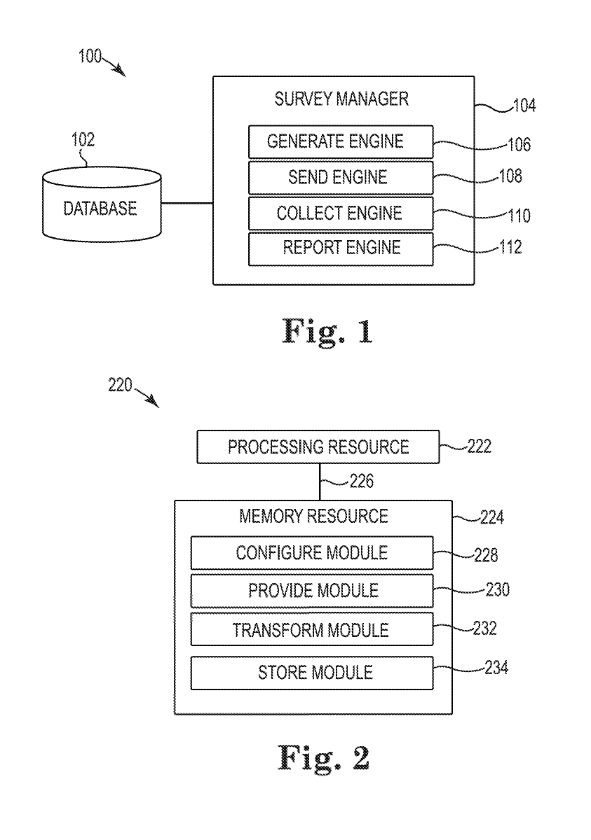

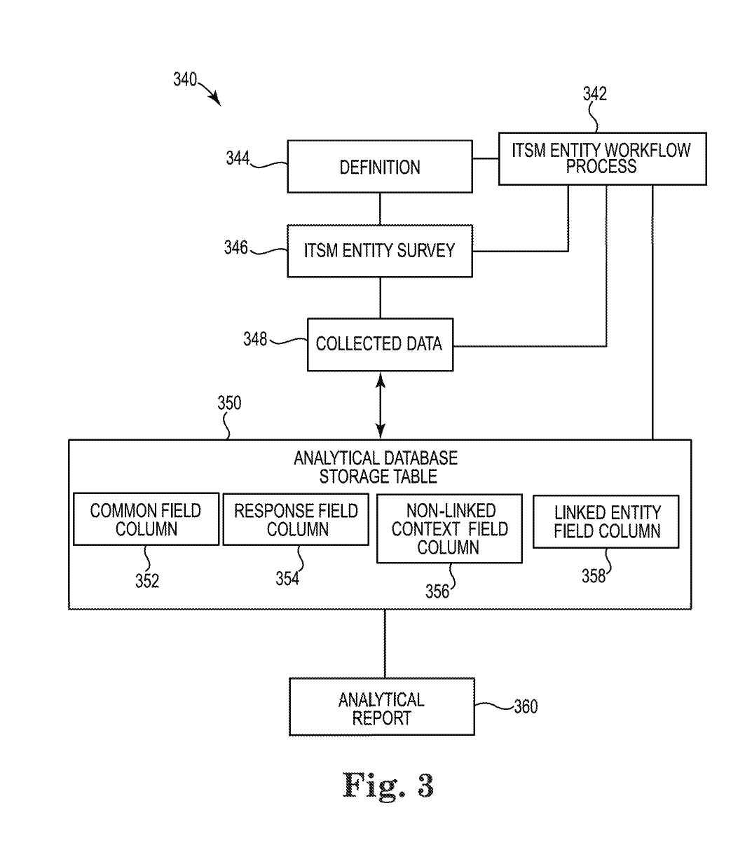

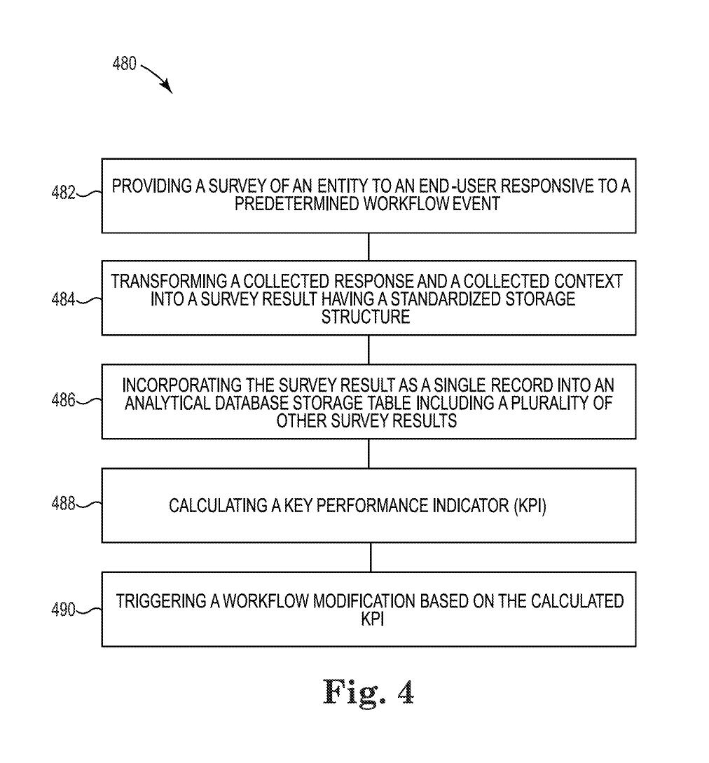

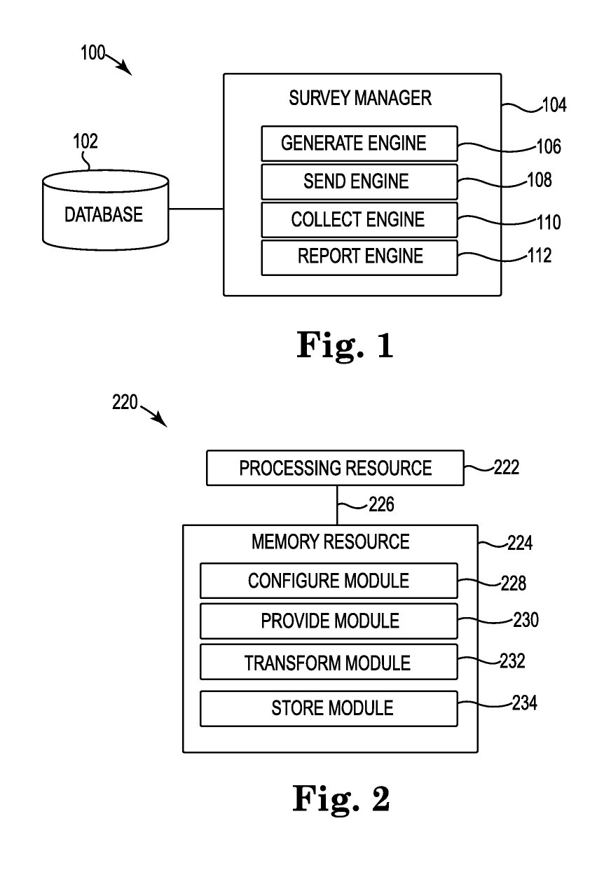

FIG. 1 illustrates an example of a survey system 100, according to examples of the present disclosure. As illustrates in FIG. 1, the survey system 100 may include a database 102, a survey manager 104, and a number of engines 106, 108, 110, and 112. The survey manager 104 may include the number of engines 106, 108, 110, and 112 in communication with the database 102 via a communication link. The system may include additional or fewer engines than illustrates to perform various tasks described herein. The survey system 100 may represent instructions and/or hardware of an ITSM software/software-as-a-service tool.

The number of engines 106, 108, 110, and 112 may include a combination of hardware and instructions (e.g. programming) to perform tasks including those described herein (e.g., generate a survey if an entity with a customized data model based on a definition, send the survey to a submitter during a workflow of a lifecycle of the entity responsive to a predetermined workflow event, collect, based in the data model, a response to the survey and a context, generate a report from a table including standardized responses and context collected from a plurality of surveys including the survey of the entity, where each of the plurality of surveys has a different customized data model etc.). The instructions can include instructions (e.g., software, hardware with instructions, etc.) stored in a memory resource (e.g., computer readable medium (CRM), machine readable medium (MRM), etc.) as well as hard-wired program (e.g., logic).

The generate engine 106 may include hardware and/or a combination of hardware and instructions to generate a survey of an entity. As used herein, a survey includes a number of inquiries to be presented to an end-user. The number of inquiries can be associated with an ITSM entity. Being associated with an ITSM entity can include providing inquires focused on the IT process underlying an ITSM entity and/or an end-users perception of some aspect of the IT process. As used herein, an ITSM entity may include the particular IT process being managed within an ITSM system. Some examples of an ITSM entity may include support request from a user experiencing an IT issue, a service request from a user with an idea for an improved IT service, and/or a change request from a user requesting a change in an aspect of his IT service. An entity may be associated with a workflow specifying an IT process for managing the entity. For example, the workflow may direct the entity through the phases of its lifecycle. As an example, in a support request entity a workflow may direct the support request to be assigned to a IT help desk group, direct the help desk group to provide a solution to the support request to an end-user, and then to close the support request brings its lifecycle to an end.

Each generated survey may have a unique and/or customized data model. As used herein, a customized data model is one that is not known to a survey engine in advance of its creation. A customized data model may include portions of a data model associated with the type of entity being surveyed, but the customized model may include additional, fewer, and/or modified fields of the data models. The fields may include the information and/or properties to be collected by the survey and/or the questions included with the survey. The data model may be defined by a survey definition received from a survey originator. The survey originator may include a process owner, assignee, and/or responsible party for the IT process underlying the ITSM entity being surveyed.

To enrich the survey data and enable insightful reports over the data collected from the survey, context of the entity and/or context of the end-user may be collected. As used herein, context may include data that contextualizes aspects of the IT process underlying the ITSM entity. Context may include, for example, data related to the ITSM entity and/or the end-user. Examples of context may include an identification of a help desk group of IT professionals that handled a support request, an identification of the process owner or assignee of the request, an identification of the end-user that opened the request, the location where the request was opened from, the desired language of the process owner or assignee, the desired language of the end user, the location of the help desk group that responded to the request, the desired language of the help desk group, an identification of the source (e.g., email, self-service portal, phone call, etc.) of the request opening, the amount of time it took to close the request, the current position of the underlying IT process within a workflow of the ITSM entity lifecycle, etc.

The send engine 108 may include hardware and/or a combination of hardware and instructions to send the survey to an end-user. The survey may be sent to the end-user during a workflow of a lifecycle of the entity. Sending of the survey may be triggered responsive to a workflow event. For example, when an IT process underlying the ITSM entity reaches a predetermined portion of the workflow (e.g., the support request is closed, the ITSM reaches a risk assessment portion of the workflow, an end-user rejects a suggested solution, etc.) the survey may be sent. The triggering portion of the workflow may be predetermined by the survey originator, process owner, assignee, etc. and be specified in the submitted definition.

The collect engine 110 may include hardware and/or a combination of hardware and instructions to collect data based on the customized data model and/or the definition of the customized data model. The data collected may include the responses of the end-user to the inquiries included in the survey. The data collected may include context data.

The report engine 112 may include hardware and/or a combination of hardware and instructions to generate a report from a table of survey results. The table may be a storage table in an analytical database. The storage table may include survey results of a plurality of ITSM entity surveys. In an example, the storage table may include survey results from a large number of ITSM entity surveys (e.g., every survey result generated within the ITSM tool). The survey results included in the storage table may include the responses and context collected for each corresponding survey. The response and context of each survey may be standardized (e.g., transformed via a normalization defined by a survey specific mapping) into a genericized structure adapted to the storage table. The storage table may contain a plurality of records, each record corresponding to the standardized response and context of a particular survey of the plurality of surveys. A portion of the plurality of surveys represented within the storage table may have customized data models that are distinct from one another. That is, the storage table can include the standardized responses and contexts of a plurality of surveys, which were based on different customized data models. Generating the report from the storage table may include presenting the results of analytical computation and/or transformation of the standardized results of the plurality of surveys as a report. Generating the report may include supporting the searching of and/or mathematical combination a portion of the plurality of records included in the storage table.

The survey system 100 may also include a transforming engine (not illustrated) that may include hardware and/or a combination of hardware and instructions to transform the collected response to the survey and the collected context to a corresponding standardized response and context to be included in the table. The transformation may create a de facto bi-directional mapping between the non-standardized collected data and the standardized data included in the table. Utilizing this di-directional mapping, the survey system 100 can include a translating engine (not illustrated) that may include hardware and/or a combination of hardware and instructions to translate, based on the bi-directional mapping, a standardized response and a standardized context included in the table into structured data for displaying in the report.

FIG. 2 illustrates an example computing device 220 according to examples of the disclosure. The computing device 220 may utilize instructions (software and/or hardware with instructions) hardware, and/or logic to perform a number of tasks including those described herein. The computing device 220 may be a combination of hardware and program instructions to share information. The hardware, for example, may include a processing resource 222 and/or a memory resource 224 (e.g., CRM, MRM, database, etc.).

A processing resource 222, as used herein, can include a processor capable of executing instructions stored by a memory resource 224. Processing resource 222 may be implemented in a single device or distributed across multiple devices. The program instructions (e.g., computer readable instructions (CRI)) may include instructions stored on the memory resource 224 and executable by the processing resource 222 to implement a desired task (e.g., configure a data model of a survey of an ITSM entity based on a definition, etc.).

The memory resource 224 may be in communication with the processing resource 222 via a communication link (e.g., a path) 226. The communication link 226 may be local or remote to a machine (e.g., a computing device) associated with the processing resource 222. Examples of a local communication link 226 may include an electronic bus internal to a machine (e.g., a computing device) where the memory resource 224 is one of volatile, non-volatile, fixed, and/or removable storage medium in communication with the processing resource 222 via the electronic bus.

A module and/or modules 228, 230, 232, and 234 may include CRI that when executed by the processing resource 222 can perform a number of tasks including those described herein. A number of modules 228, 230, 232, and 234 may be sub-modules of other modules. For example, the configure module 228 and the provide module 230 may be sub-modules and/or contained within the same computing device. In another example, the number of modules 228, 230, 232, and 234 may comprise individual modules at separate and distinct locations (e.g., CRM, etc.).

Each of the number of modules 228, 230, 232, and 234 may include instructions that when executed by the processing resource 222 may operate as a corresponding engine described herein. For example, the configure module 228 may include instructions that when executed by the processing resource 222 may operate as the generate engine 106. The provide module 230 may include instructions that when executed by the processing resource 222 may operate as the send engine 108. The transform module 232 and the store module may include instructions that when executed by the processing resource 222 may operate as the report engine 112.

The configure module 228 may include instructions that when executed by the processing resource 222 may configure a data model and data analysis of a survey concerning an ITSM entity and its underlying IT process. The data model may be configured based on a definition. The definition may be provided by a survey originator. Configuring the data model may include selecting an entity type related to the ITSM entity being surveyed. For example, if the ITSM entity is a request from an end-user for a solution relating to failed remote logins to an organization server, configuring the data model may include selecting a support request entity type as that is the type associated with such a request. Selecting an entity type may provide a starting frame work of a data model to be customized for the particular ITSM entity that is the subject of the survey.

Configuring the data model may further include mapping ITSM entity context fields, survey response fields, end-user context fields, and custom expression fields to be populated with collected data. The data collected may be targeted for collection based on the data model configuration. For example, if the data model is to include a mapping of an identity of a help desk group assigned to an IT process underlying the surveyed ITSM entity, the data identifying the assigned help desk group can be targeted for collection. Configuring the data model may further include receiving a definition of display attributes, a title, instructions, and/or inquiries to be included in the survey. Configuring the data model may include receiving and configuring the data collection for and calculation of key performance indicators (KPI) from the survey. As used herein, a KPI may include a metric of the end-user or the ITSM entity being surveyed and/or its underlying IT process. A KPI may include a metric associated with the response and/or the context to be collected from the survey that can be feed into a workflow process of the ITSM entity. Configuring the data model may also include configuring reports to be generated that leverage the collected data of the survey. Furthermore, configuring the data model may include receiving the definition of and configuring automatically executable rules within the ITSM entity process workflow. The automatically executable rules can serve as automatic triggers to trigger the provision of the survey to an end-user responsive to a predetermined workflow event.

The provide module 230 may include instructions that when executed by the processing resource 222 may provide the survey of the ITSM entity to its defined audience. Providing the survey may include transmitting the survey to an end-user responsive to a triggering event in the workflow of the ITSM entity as specified in the configuration. For example, the survey may be electronically transmitted to an end-used responsive to the provision of a requested solution to the ITSM entity support request subject of the survey.

The transform module 232 may include instructions that when executed by the processing resource 222 may transform a collected survey response and a collected context into a survey result. The collected survey result may include the responses collected form the end-user. The collected survey response may include collected data targeted for collection by the definition/configuration of the data model. The collected survey result may include context associated with the survey originator, the assignee, the ITSM entity, the end user, and associated data. The collected survey context may include collected data targeted for collection by the definition/configuration of the data model.

Transforming the collected survey response and the collected context into a survey result can include normalizing the collected survey response and the collected context into standardized storage structure. As used herein, the standardized storage structure may include normalized values corresponding to the collected data where the normalized values are designated for and/or organized into columns corresponding to a plurality of column types present in a generic analytical database storage table. The transformation may transform raw and/or non-normalized collected data from a plurality of surveys having a plurality of different data models into data having a common standardized storage structure. The transformation of the collected survey response and the collected context may be based on a survey-specific mapping conversion. As used herein, a survey-specific mapping function may include a transformative mathematical operation applicable to the raw collected data. The transformative mathematical operation may be used to transform raw data values into normalized standard values. The transformative mathematical operation can be applied to different portions of the collected raw data based on a designation of a data type associated therewith. The designations may be derived from the definition and/or configuration of the data model. For example, a portion of the collected data may include the email address of the end-user and that portion of the data may be designated as an email address mapping to a contact information email field. The survey-specific mapping conversion may not rely on a pre-existing knowledge of the customized data model associated with the survey. Rather, the survey-specific mapping conversion may piecemeal convert collected raw data into the normalized standard form based on the data designations.

The store module 234 may include instructions that when executed by the processing resource 222 may store the survey result in an analytical database storage table. The survey result, including the transformed survey response and the collected context, may be stored as a single record in an analytical database storage table. The analytical database storage table may contain survey from a plurality of different surveys having a plurality of different customized data models. However, the survey results stored in the analytical database storage table may be stored in the standardized data structure generic to the analytical database storage table. That is, while the collected data included in the analytical database storage table may be sourced from distinct customized data models of the plurality of surveys, all the records in the analytical database storage table can have a standardized data structure resulting from the transformation of the underlying collected data.

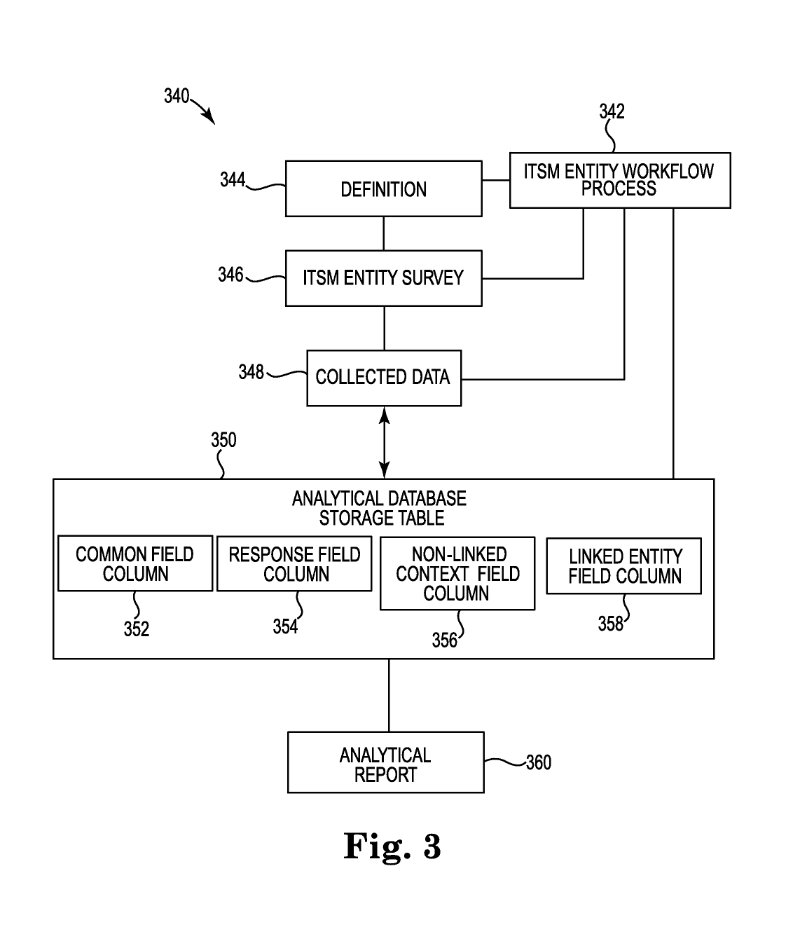

FIG. 3 illustrates an example environment 340 according to the disclosure. The environment 340 may include an ITSM entity workflow process 342, a definition 344, an ITSM entity survey 346, collected data 348, an analytical database storage table 350, common field column 352, response field column 354, non-linked context field column 356, and/or linked entity field column 358. The definition 344 may be a number of definitions and/or configurations provided from a process owner, assignee, and/or responsible party for the IT process underlying the ITSM entity being surveyed. The definition 344 may define the customized data model of the ITSM entity. That is, the definition 344 may define the attributes and properties of the display, title, instructions, and inquiries included in a survey of the ITSM survey. For example, the process owner may define a new survey including the survey metadata and the questions to be included in the questionnaire portion of the survey. The definition 344 may also include a definition of the ITSM entity type and an associated ITSM entity model that the survey is defined on (e.g., a support request).

The definition 344 may include a mapping of various data to be collected throughout the survey process. For example, when a process owner defines a new survey the process owner may provide a definition 344 including a mapping of ITSM entity fields (fields of data associated with the ITSM entity and/or the IT process underlying the ITSM entity being surveyed) and additional custom expressions to be collected along with the responses to the inquires of the survey. When a process owner defines a new survey the process owner may provide a definition 344 including a mapping of end-user fields (fields of data associated with the end-user, submitter of the survey, and/or the submission process of the survey response) and custom expressions to be collected along with the responses to the inquires of the survey. The data in these mappings (e.g., ITSM entity fields, ITSM entity custom expressions, end-user fields, end-user custom expressions) may be the context (e.g., contextual data of the ITSM entity, end-user, and the survey process) collected through the survey process. The data collected during the survey may be limited to the data defined for collection in the definition 344, or the data defined for collection may be a portion of the ITSM entity and end-user fields collected and saved. The data defined for collection in the definition 344 may be a context of interest (e.g., the contextual data that the process owner is interested in or deems interesting for the purpose of future analysis) and/or the process owner may provide a separate indication of context of interest in the definition 344 identifying specific entity and user fields that should be collected and saved as potentially interesting data for incorporation into reports.

The definition 344 may include definitions of KPIs. The definition 344 may include defining specific KPIs and methods for their calculation but also defining threshold values with respect to the KPIs. Moreover, the definition 344 may include a definition of how the KPIs and KPI threshold comparisons are incorporated as feed back into the ITSM entity workflow process 342. For example, the definition 344 may include an instruction that a risk indicating KPI can have various workflow triggering effects based on where the KPI value is in relation to a threshold KPI value.

The definition 344 may include report configurations that configure the generation of reports that leverage the collected data. For example, the definition 344 may define reports to be generated over the inquiries in the survey, the context of the end-user, or the context of the ITSM entity. The report definitions may define what reports to run, the calculations to be performed to generate the report, the data to be included in the report, the frequency with which the report should be generated, and/or an amount of time between reports.

The definition 344 may include a configuration of survey execution. For example, the definition 344 may include a definition of automatically executable rules in the ITSM entity workflow process 342. The rules may define the exact changes in the ITSM entity workflow process 342 that trigger sending the ITSM entity survey 346 and to whom the ITSM entity survey 346 is sent in response to those triggers.

The definition 344 may include a workflow event in the ITSM entity workflow process 342 and/or any outcome of any event in the ITSM entity workflow process 342. For example, the definition 344 may specify that the ITSM entity survey 346 associated with a change-risk assessment can be sent following the completion of estimation and planning of the change but prior to the execution of the change. In contrast to a relatively simple ITSM trigger of sending a survey to an end-user upon closing of a request regardless of the reason the request was closed, the definition 344 can include any triggering condition and/or workflow event within the ITSM entity life cycle.

This increased granularity in ITSM entity survey 346 triggering can allow for more precise and poignant surveying. For example, where an ITSM tool sends surveys upon the closing of the request, the survey may be a generic catch all survey for request closings (e.g., “were you satisfied with the handling of your request?”, etc.). However, examples herein may allow a more targeted surveying in that very specific occasions can trigger an ITSM entity survey 346. For example, there may be an occasion where you already know that an end-user is dissatisfied with how the request was handled (e.g. request was closed as a result of an end user rejecting a provided solution, etc.) and rather than transmit the generic survey asking if they are satisfied an ITSM entity survey 346 can be triggered that delves deeper into what happened to bring about the dissatisfaction. In this manner, a survey engine is effectively integrated into the ITSM entity workflow process 342.

Once a triggering condition and/or workflow event, as defined by the automatically executable rules defined in the definition 344, is detected in the ITSM entity workflow process 342 the ITSM entity survey 346 may be executed. Execution of the ITSM entity survey 346 may include providing the ITSM entity survey 346 to the defined end-users for submission of a response. Execution of the ITSM entity survey 346 may include collecting data 348. The collected data 348 may include the collected responses (e.g., end-user answers to the survey, etc.) and context (e.g., ITSM entity contextual data, end-user contextual data, etc.) identified for collection in definition 344. The execution of the ITSM entity survey 346 may include saving the collected data 348 stored as a single survey result object in an intermediate key-value storage optimized for concurrent insert operations.

The environment 340 can include an analytical database storage table 350 in an analytical database. The analytical database may be a database built to store, manage, and/or consume large amounts of data. The analytical database may include and/or interface with business analytics, big data, and business intelligence solutions such as an ITSM tool. The analytical database can include integrated features to support the storage and retrieval of data from use in analytics applications. The analytical database may support the ability to dynamically add columns and rows, modify schemas, search data through a plurality of attributes, and/or conduct in-memory loading of data in a compressed format. The analytical database storage table 350 may include a single table storing a plurality of survey results from an organizations system. Each survey result may be stored as a single record within the analytical database storage table 350. The analytical database storage table 350 may have a schema that is generic on one hand, bet able to accommodate data from the different surveys and context on the other. In order to support analytics and report generation over the data in analytic database storage table 350, the analytic database storage table 350 may be a table including over two hundred and fifty columns of differing types to support the collected data 348 over the range of possible ITSM entities supported by an organizations ITSM tool. For example, the analytic database storage table 350 can include four types of columns for storing corresponding data: common field column 352, response field column 354, non-linked context field column 356, and/or linked entity field column 358.

The common field column 352 may include a column that is common to a plurality of surveys independent of the customized data models. For example, the common field column 352 may include a survey ID, an end-user ID, a submission time, a survey version, etc. The response field column 354 may include integer columns representing a response to each inquiry as a normalized number of integers based on the type of inquiry, where each integer is saved to a column accordingly. The non-linked context field column 356 may include end-user properties and/or context entity properties which were defined as interesting in definition 344. The end-user properties and/or context entity properties may be saved in a single text column in the table, with the exception of links to other entities within an ITSM system. The linked entity field column 358 may include links to other entities to support displaying joined data from other tables (e.g., a help desk group or location table). The analytic database storage table 350 may include predefined columns for each link type to support such joint operations.

In order to store the collected data 348 into the analytical database storage table 350, the collected data 348 may be transformed into a survey result having a standardized storage structure compatible with the storage schema of the analytical database storage table 350. The transformation of the collected data 348 may be based on a survey-specific mapping function and each standardized survey result can be saved as a single record in the analytical database storage table 350. Each survey in the analytical database storage table 350 may have different questions and/or different context. Through construction of a unique translating operation (e.g., a mapping) between the ITSM entity survey 346 and a set of corresponding columns in the analytical database storage table 350 a survey-specific mapping function may be created. The ITSM entity data model does not need to be known in advance of constructing the unique translating operation since the construction of the mapping can be dynamically calculated when the ITSM entity survey 346 is created. Application of the unique translating operation to the collected data 348 (e.g., the survey result) may transform the collected data 348 to a normalized form (e.g., data values corresponding to the columns 352, 354, 356, and/or 358) representing a standardized storage structure compatible with the schema of the analytical database storage table 350. The transformed collected data 348 may be stored in its normalized format as a single record in the analytical database storage table 350.

The above described transformative normalization may provide flexibility in that the process owner of each of the ITSM entity surveys included in an analytical storage database can define different end-user and/or ITSEM entity context fields as interesting. Moreover, a process owner and/or an analytics process user may define a calculated field using nested expressions. Defining a calculated field using a nested expression may include taking data from a field within an ITSM entity. For example, when an end-user fills out a survey the actual answers to the survey are collected, the end-user context may be collected, and/or the context about the ITSM entity and the undedying IT process may be collected. Data from a combination of those sources can be combined to generate interesting information. For example, it may be interesting to determine whether the end-user had a preference for the same language as the person that responded to the request because the satisfaction of the end-user with the provided solution can be effected by the end-user's ability to clearly understand the responding person providing the solution. To explore this relationship, a nested expression may be used such as a Boolean string search stored in the ITSM entity survey 346 which can be used to later generate reports exploring the correlation of language identity and satisfaction with the request. An example nested expression may include “request?help desk group?Location?County.”

The unique translating operation (e.g., a mapping) applied to the collected data 348 may be bi-directional. That is, the unique translating operation may operate as a map back and forth between the collected data 348 and the normalized form saved in the analytical database storage table 350. This may allow for translating each survey result to a single standardized storage structure for storage in the analytical database storage table 350, and allow for translating back each record in the analytical database storage structure 350 into a structured data for displaying in reports.

The environment 340 may include an analytical report 360. The analytical report 360 may include a report generated from the data including in the analytical database storage table 350. That is, the report can be an analysis and/or calculation of the stored normalized metrics from a plurality of different ITSM entity surveys. While each of the plurality of ITSM entity surveys whence the normalized metrics came may have had different customized data models, the analytical report 360 may seamlessly incorporate the metrics since they are accessible in their normalized form within the analytical database storage table 350. That is, since the collected data from each ITSM entity survey is normalized and saved as a single record in the analytical database storage table 350, analytical reports 360 are able to be generated over the entire body of data in the analytical database storage table 350 regardless of the original customized data model associated with the corresponding ITSM entity survey. The analytical reports 350 can be calculated periodically from the analytical database storage table 350. The analytical reports 350 can be generated by a reporting system built over the analytical database storage table 350.

As mentioned above, the definition 344 may include a definition of KPIs and/or associated KPI thresholds. KPIs and/or the results of a comparison of a KPI to an associated KPI threshold can be fed back into the ITSM entity workflow process 342. KPIs and their relationship to an associated KPI threshold may be utilized as triggers within the ITSM entity workflow process 342. For example, a KPI may be utilized to modify the workflow of an IT process underlying the ITSM entity. Modifying the workflow can include allowing the IT process to proceed to the next step in a workflow, removing the IT process from a workflow, and/or generating a new workflow for the ITSM entity. In this manner the feedback from the survey is incorporated into the ability of the IT process to proceed through the ITSM entity workflow process 342.

The KPIs may be calculated upon completion of the execution of the ITSM entity survey 346. KPIs may be calculated continually. KPIs may be calculated from the analytical database storage table 350. The calculated KPIs may be fed back into the ITSM entity workflow process 342. The calculated KPIs may be fed back into the ITSM entity workflow process 342 upon a timer call and/or upon an ITSM entity survey end time.

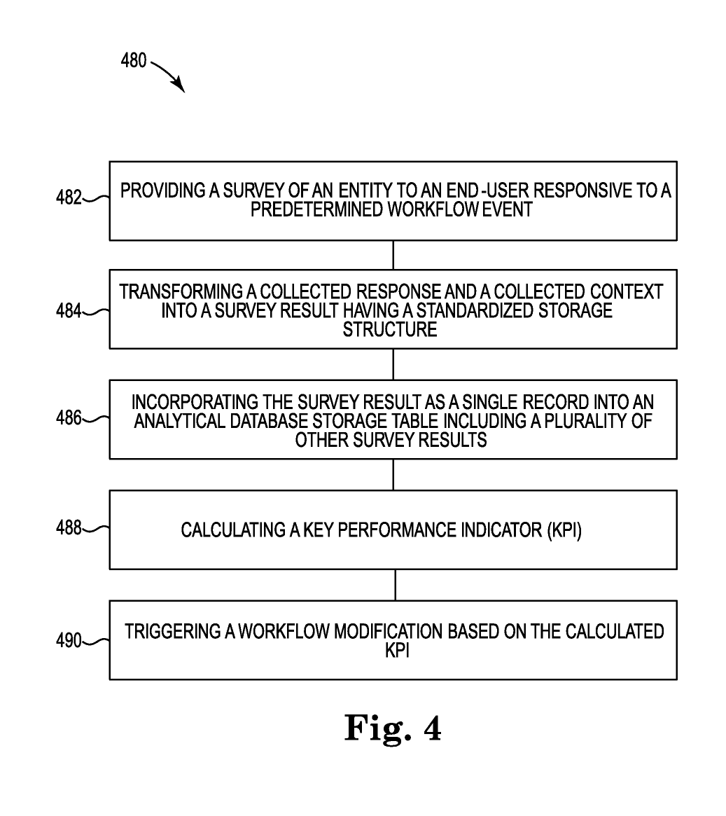

FIG. 4 illustrates a flowchart of an example method 480 according to examples of the disclosure. The example method 480 may be implemented in the environment 340 illustrated in FIG. 3, using the system 100 illustrated in FIG. 1 and/or the computing device 220 illustrated in FIG. 2.

At 482, the method 480 may include providing a survey of an ITSM entity to an end-user. The provision of the survey may be responsive to the occurrence of a predetermined workflow event such as those occurring during the course of a lifecycle of the ITSM entity. The predetermined workflow event may be a workflow event identified in a definition of the ITSM survey. The predetermined workflow event may be feedback into the ITSM entity workflow process in the form of a KPI and/or KPI comparison. The KPIs may be generated from data in an analytical database table and feedback into the ITSM entity workflow process as a triggering event.

At 484, the method 480 may include transforming a collected response and a collected context into a survey result having a standardized storage structure. The transformation may include the construction and application of a survey-specific bi-directional mapping between the collected response and collected context to column types in an analytical database storage table. The transformation may also include the normalization of survey responses from their original form(s) (e.g., text responses, radio button selection, number, letter, etc.) into integers representing the communicated response (e.g., 0=No, 1=Yes, etc.).

At 486 the method 480 may include incorporating the survey result as a single record into an analytical database storage table including a plurality of other survey results. The survey results may be incorporated into corresponding columns of the analytical database storage table. Regardless of the original customized data model and specific identified contexts of interest associated with each of the plurality of surveys in the table, the analytical database storage table may contain a normalized version of the data collected from the plurality of surveys.

At 488, the method 480 may include calculating a KPI. Calculating a KPI may include calculating a value from a normalized metric from the plurality of surveys in the table. Calculating a KPI may include comparing a calculated KPI to an associated KPI threshold. Calculating a KPI may include providing the calculated KPI as feedback into a workflow of an IT process.

At 490, the method 480 may include triggering a workflow modification based on the calculated KPI. Triggering a workflow modification may include automatically executing a change included in a change request in response to a collected risk indicating KPI indicating that the risk associated with executing the change is below a threshold value. Additionally, triggering a workflow modification can include forwarding a change request for a manual review in response to a risk indicating KPI indicating a risk associated with executing the change exceeds a threshold value.

In the disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the disclosure. In addition, the proportion and the relative scale of the elements provided in the figures are intended to illustrate the examples of the disclosure, and should not be taken in a limiting sense.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a number of” something can refer to one or more such things. For example, “a number of widgets” can refer to one or more widgets. Also, as used herein, “a plurality of” something can refer to more than one of such things.

The above specification, examples and data provide a description of the method and applications, and use of the system and method of the disclosure. Since many examples can be made without departing from the spirit and scope of the system and method of the disclosure, this specification merely sets forth some of the many possible configurations and implementations.

What is claimed is:

1. A system, comprising:
a generate engine to generate, based on a definition, a survey of an entity having a customized data model;
a send engine to send the survey to an end-user during a workflow of a lifecycle of the entity responsive to a predetermined workflow event;
a collect engine to collect, based on the definition, a response to the survey and a context; and
a report engine to generate a report from a table containing standardized responses and standardized contexts collected from a plurality of surveys including the survey of the entity, wherein each of the plurality of surveys has a different customized data model.

2. The system of claim 1, wherein the definition includes an inquiry to be included in the survey, an information technology service management (ITSM) entity type associated with the survey, and a context of interest.

3. The system of claim 2, wherein the collected response to the survey is a response of the end-user of the ITSM entity to the inquiry and the context is the context of interest.

4. The system of claim 2, wherein the context of interest is a data field to be populated with specified information about the ITSM entity and a data field to be populated with specified information about the end-user.

5. The system of claim 2, wherein the definition further includes a key performance Indicator (KPI) to be used as a trigger in the workflow of the lifecycle of the ITSM entity.

6. The system of claim 1, further comprising a transforming engine to transform the collected response to the survey and the collected context into a corresponding standardized response and context included in the table.

7. The system of claim 1, further comprising a translating engine to translate, based on a bi-directional mapping, a standardized response and a standardized context included in the table into a structured data for displaying in the report.

8. A non-transitory computer readable medium storing instructions executable by a processing resource to:
configure a customized data model of a survey of an information technology service management (ITSM) entity based on a definition;
provide the survey to an end-user during a workflow of a lifecycle of the entity responsive to a specified workflow event;
transform a collected survey response and a collected context into a survey result having a standardized storage structure based on a survey-specific mapping; and
store the survey result as a single record in an analytical database storage table containing a plurality of survey results formatted to the standardized structure.

9. The medium of claim 8, wherein the standardized storage structure includes survey information of a type common to the plurality of survey results for insertion into a corresponding column type of the analytical database storage table.

10. The medium of claim 8, wherein the standardized storage structure includes a number of integers representing a normalization of the survey response for insertion into a corresponding column type of the analytical database storage table.

11. The medium of claim 8, wherein the standardized storage structure includes a non-linked end-user property and a non-linked ITSM entity property derived from the collected context for insertion into a corresponding column type of the analytical database storage table.

12. The medium of claim 8, wherein the standardized storage structure includes a link to another entity to support displaying joined data from another table for insertion into a corresponding column type of the analytical database.

13. A method, comprising:
providing a survey of an information technology service management (ITSM) entity to an end-user responsive to a predetermined workflow event;
transforming a collected response and a collected context into a survey result having a standardized storage structure;
incorporating the survey result as a single record into an analytical database storage table including a plurality of other survey results;
calculating a key performance indicator (KPI); and
triggering a workflow modification based on the calculated KPI.

14. The method of claim 13, wherein the entity is a change request and wherein triggering the workflow modification includes automatically executing a requested change in response to the calculated KPI indicating a risk associated with executing the change is below a threshold value.

15. The method of claim 13, wherein the entity is a change request and wherein triggering the workflow modification includes automatically forwarding a requested change for a manual review in response to the calculated KPI indicating a risk associated with executing the change exceed a threshold value.
